(19) United States
(12) Patent Application Publication
(10) Pub. No.: US 2010/0194563 A1
(43) Pub. Date: Aug. 5, 2010

(54) SECURED ROOM MONITORING

(76) Inventors: John M. Berner, Golden Valley, MN (US); Stephen Young, Minneapolis, MN (US)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/646,773

(22) Filed: Dec. 23, 2009

Related U.S. Application Data
(60) Provisional application No. 61/140,521, filed on Dec. 23, 2008.

(51) Int. Cl. G08B 13/08; G01L 1/04

(52) U.S. Cl. 340/545.1; 73/862.621

(57) ABSTRACT

A system and method for providing warnings of a suicide attempt provides monitoring of specific hardware, fixtures, or objects, or structure supporting or associated with same, within an isolation room by way of sensors to provide notice exterior the room that a monitored condition has changed. The sensor can be a load sensor, proximity sensor, contact sensor, or the like. More particularly, an object in an isolation room that provides an attachment potential for hanging is monitored such as by monitoring the load of said object, detecting changes in the load, and providing an alarm of the change in condition. Doors and associated hardware are particularly suitable for such monitoring.

### PRIORITY

The present application claims the benefit of U.S. Provisional Application No. 61/140,521, filed Dec. 23, 2008, which is incorporated herein in its entirety by reference.

### FIELD OF THE INVENTION

The present invention relates to secured rooms, more particularly, the present invention relates to a monitoring system for monitoring the loading on a door and other objects in the secured room, particularly for suicide prevention.

### BACKGROUND OF THE INVENTION

Monitoring of patients in hospitals, and especially incoming patients with potential psychiatric conditions, is often a necessity to prevent patients from causing harm to themselves or even taking their own lives. One way in which patients have been known to cause such harm is by hanging themselves when placed in isolation rooms. Patient monitoring is often done through surveillance, either in person or on closed circuit television. Monitoring must essentially be constant, because a lapse of only a few minutes could provide enough time for a patient to hang him or herself from a door. Medical facilities will often not have the capabilities or manpower to constantly visually monitor all patients in isolation. Although rooms where patients are kept in isolation can be designed to minimize hardware or fixtures that may be used by a suicidal patient, not all such hardware and fixtures can practically be removed. It would therefore be desirable to have a way to monitor and alert appropriate personnel if it appears a patient is attempting to take his or her own life by utilizing such hardware or fixtures or other objects in a suicide attempt.

### SUMMARY OF THE INVENTION

In an embodiments, a system, method, and devices for providing warnings of a suicide attempt provides monitoring of specific hardware, fixtures, or objects, or structure supporting or associated with same, within an secured isolation room. Sensors provide signals exterior the room that a monitored condition has changed. In an embodiment the sensor is a load sensor. More particularly, an object in an isolation room that provides an attachment potential for hanging is monitored such as by monitoring the load of said object, detecting changes in the loading of the object, and providing an alarm when the change in loading exceeds a predetermined parameter.

In an embodiment, a door assembly includes a door and a door frame connected by a hinge. A load cell or other sensor can be disposed intermediate the door frame and door to measure the load caused by the door. The door frame can include a plurality of openings containing supports for connecting the hinge and door to the door frame. One of the supports can carry the load of the door and can include the load sensor. The other supports can support a portion of the weight of the door and can have some vertical freedom of movement, that is, in the y direction in the x-y-z coordinate plane. The other supports can provide horizontal constraints such that the door hinge at the door frame does not move significantly or noticeably in the x-z plane. The door may secure a secured room and the sensor may be connected to a remote monitoring portion that can sound appropriate alarms or otherwise notify appropriate individuals of the status of the monitored secured room.

In another embodiment, a door sensor assembly can include a door connected to a door jamb with a hinge assembly having two hinge halves connected by a pin. A bearing can be located at the bottom of pin and can bear against, directly or indirectly, a load sensor disposed within a sensor bracket affixed to door jamb. Load sensor can measure the load on the door and changes to the load on the door. Resilient washers can be positioned along hinge assembly to distribute the door load in order to prevent an undue amount of force from being continually placed on the load sensor. Load sensor can provide a signal regarding the load on the door to a central monitoring station, thereby alerting personnel at central monitoring station if the load is substantially increased, such as if it is being used to support a person's weight. The systems and or sensors described herein can be arranged to be operative only when the door is closed, or when a patient is present, and as otherwise selected.

In an embodiment, a system can monitor a load placed on one or more doors. The system can include at least one door, door frame and hinge connecting the door to the door frame. A sensor can be configured to take measurements of a load caused by the door and transmit a signal indicative of the measurements to a remote monitoring station that allows remote monitoring of the load. The remote monitoring station can be configured to receive a plurality of signals relating to a plurality of sensors. The remote monitoring station can also be configured to provide an alarm if the signal indicates that the load has increased.

A feature and advantage of embodiments of the invention is that a load placed upon a door or other object, fixture, or hardware can be monitored. A sensor monitors the load caused by the door or other object, fixture, or hardware, and an increase in the load indicates that an additional load has been placed upon the door. Therefore, appropriate personnel can be notified to investigate the cause of the increased load such as by an alarm sounding.

A further feature and advantage of embodiments of the invention is decreased response time to load increases on doors, which may indicate suicide attempts. The system can be setup such that a single monitoring station monitors a number of sensors positioned in different locations, so that an increased load on any of the sensors is instantaneously communicated back to the monitoring station. This allows the appropriate personnel to respond more quickly to and prevent any potential problems, such as suicide attempts.

Another feature and advantage of embodiments of the present invention is that the manpower necessary to monitor numerous patient or isolation rooms is decreased. Because the load on the doors and/or other monitored objects in the rooms can all be monitored from a single monitoring station, fewer monitoring personnel are necessary.

A further feature and advantage of embodiments of the present invention is that patient safety is increased. Because appropriate personnel can respond more quickly to a potential problem with the present invention, the likelihood of patient harm is decreased.

In an embodiment of the invention, a monitoring system associated with a plurality of patient rooms or secured rooms includes a remote monitoring portion and sensors associated with objects in the rooms that have attachment potential that could be used for causing harm such as by suspending or hanging of patients. Sensors may provide indications of weight change relating to the object, particularly weight addition, touching of the object, or other tampering. The sensors may be contact sensors, such as capacitive sensors, load cells, strain gauges, proximity sensors, or the like suitable to detect such tampering or change in conditions of the objects, as well as presence of patients. The sensors may be attached to or at the support structure supporting the objects or intermediate the object and secured room structure to monitor the loading from the object. The sensors are in communication with the monitoring portion by hardwiring, rf means, fiber optic, ir means or other communication means. The sensors may be active with circuitry and individual power sources at or proximate the sensing location or the patient room, or may be passive with direct wiring to the monitoring portion. The sensors may be periodically polled or continually monitored. The sensors for particular rooms may be configured to operate in coordination, such as presence detection of a patient or personnel in the room which may then activate the sensors to detect tampering or loading of objects. Different types of sensors, as well as a plurality of sensors may be utilized in each patient room. The sensors may have direct wiring to provide an indication in sensing condition, such as load change, to the monitoring portion which may then go to an alarm status to indicate to attendants the presence of an issue. Multiple monitoring stations may be provided to provide monitoring of multiple patient rooms in different locations throughout a facility such that when an alarm is sounded, ready visual access to information is provided in the different locations throughout the facility to aid in quick response to the specific room. Specific alarm status indication may be provided immediately outside of a room where an alarm triggering signal originated. Typically, the alarm condition will be activated when the sensed condition deviates outside a particular parameter range, said parameter range generally being adjustable either at the sensor, at the monitoring station, or both. In certain embodiments, the sensor may be a switch which is activated when a certain level of loading or a certain condition is present.

In an embodiment of the invention, patient isolation rooms can be visually surveyed and inspected to identify objects, fixtures, or hardware that can be utilized by patients intent on harming themselves such as by hanging and to then provide weight monitoring sensors connecting to said objects, fixtures, or hardware to provide an alarm condition when the effective weight loading of such identified objects, hardware or fixtures increases. In an embodiment, the weight monitoring sensors may be provided on support hardware to sense loading on the support hardware. In an embodiment, hardware may be replaced with sensor-embedded hardware, such as load sensing supports, that can sense relative loading whilst providing support. Loading may be sensed by monitoring a component deflection or compressive loading or tensile loading of a support member and detecting a change in same, or a change beyond a predetermined value.

In an embodiment of the invention gravitational loading on particular objects, fittings, and hardware in an isolation room may be monitored to provide an alarm condition when such loading increases beyond predetermined parameters suggesting a suicide gesture or attempt. The objects, fittings and hardware can include, but not limited to, a door providing access to the secured or isolation room or other door in the room, cabinets in the room, light fixtures, ceiling structure or ceiling support structure, fire control equipment, shelf structure, signage, and window hardware.

In an embodiment, an object of significant weight can be hung from a building structure in a secured room, whilst supported by a plurality of resilient supports to provide secure support. A load sensor positioned intermediate the building structure and object of significant weight can monitor any change of loading at the object of significant weight thereby indicating a secured person is tampering with the object such as by a suicide attempt. A monitor portion can activate alarms. The load sensor can be part of one of the supports.

A specific embodiment of the invention is providing a plurality of horizontal leaf springs for supporting a door hinge. An advantage and feature is that the leaf springs allow a measurable vertical deflection of the door with respect to the door frame from which the door is hung, whilst not allowing any significant horizontal deflection, and not interfering with the functional operation of the door. Such deflection may be measured by strain gauges or the compressive force provided on a load cell. Such leaf springs or load cells may be mounted in the door frame or within the door.

In an embodiment of the invention, the deflection of a support member of a door is monitored and when said deflection exceeds a certain amount, said deflection is sensed and an alarm is sounded. An embodiment utilizes a plurality of resilient members to provide support for an entrance door to the isolation room, the resilient members provide a deflection of support members, the door and door frame are configured such that the deflection of the support members does not affect the functional operation of the door in the door frame. Moreover, the deflection of the support members changes when additional weight is added to the door. Sensors are attached to at least one of the support members to monitor and provide an indication when “an additional weight” is added to the door. Such sensors may be strain gauges mounted on leaf springs or cantilevered members extending horizontally, a load cell where at least a portion of the weight of the door is supported by and is transferred though such a load cell, or other weight monitoring sensor arrangements.

Another feature and advantage of embodiments of the present invention is that existing facilities can be retrofit with the present invention. Existing doors and hinges can be removed and sensors as described herein can be installed into the existing door frame. The existing door or a new door can then be configured to have its load measured and monitored by the sensor and system. Support hardware for other objects, fixtures, or hardware can be supplemented or replaced with loading capable sensors.

### BRIEF DESCRIPTION OF THE FIGURES

These as well as other objects and advantages of this invention, will be more completely understood and appreciated by referring to the following more detailed description of the presently preferred exemplary embodiments of the invention in conjunction with the accompanying drawings of which:

FIG. 1 is a schematic representation of aspects of the present invention.

FIG. 2 is a partial exploded view of a door assembly according to an embodiment of the present invention.

FIG. 3 is a partial exploded view of the door assembly of FIG. 2.

FIG. 4 is a partial exploded view of the door assembly of FIG. 2.

FIG. 5 is a front view of a load sensing support according to an embodiment of the present invention.

FIG. 6 is a partial cross-sectional side view of the load sensing support of FIG. 5 taken at line 6-6.

FIG. 7A is a view of a fixed support according to an embodiment of the present invention.

FIG. 7B is a view of a resilient support without a sensor according to an embodiment of the present invention.

FIG. 7C is a view of a resilient support according to an embodiment of the present invention.

FIG. 7D is a view of a resilient support according to an embodiment of the present invention.

FIG. 7E is a partial cross-sectional view of a resilient support according to an embodiment of the present invention.

FIG. 7F is a partial cross-sectional view of a resilient support according to an embodiment of the present invention.

FIG. 8 is a schematic representation of a load sensing system according to an embodiment of the present invention.

FIG. 9 is a partial exploded view of a load-sensing door assembly according to an embodiment of the present invention.

FIG. 10 is a partial front view of a load-sensing door assembly according to an embodiment of the present invention.

FIG. 11 is a flowchart depicting a process for configuring a monitoring system software application according to an embodiment of the present invention.

FIG. 12 is a flowchart depicting a monitoring process according to an embodiment of the present invention.

FIG. 13 is a flowchart depicting a monitoring process according to an embodiment of the present invention.

FIG. 14 a partial cross-sectional view of a door assembly according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION

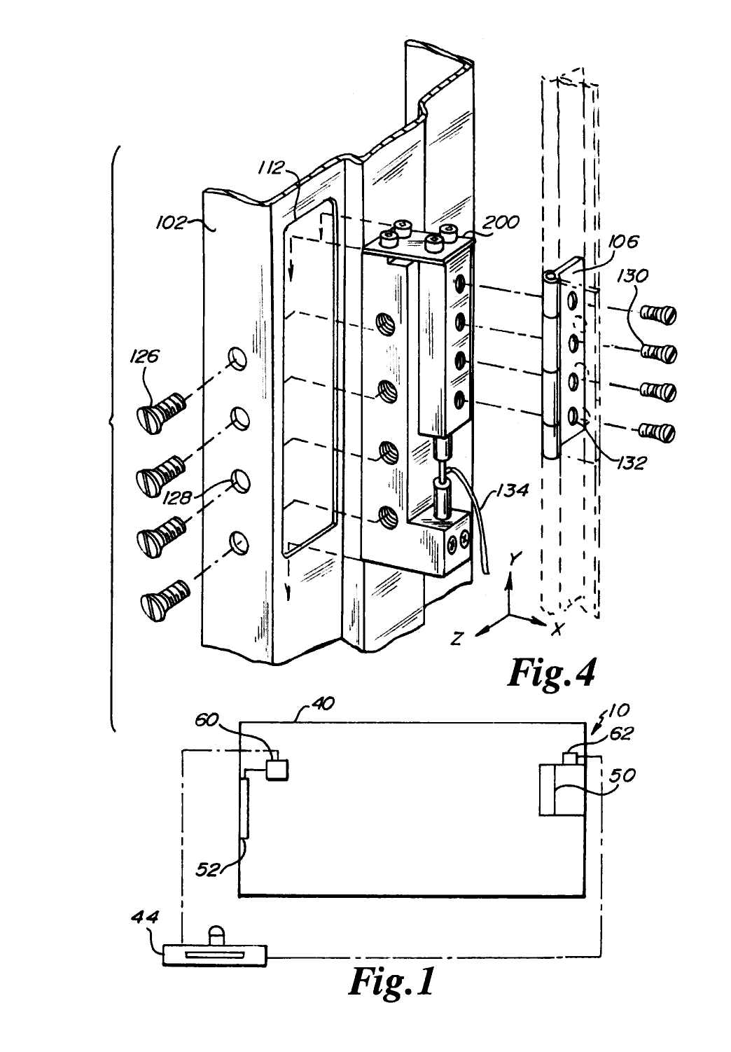

Referring to FIG. 1, an embodiment of the invention is represented as a system 10 associated with a second isolation room 40 and including a remote monitoring portion 44. The isolation room has objects 50 and 52 that are supported within the isolation room and present potential for self-induced harm by hanging. Sensors 60, 62 are attached to the support structure or intermediate the object and the room structure to monitor the load of the object. The sensors are in communication with the monitoring portion by hardwiring, rf means, fiber optic, ir means or other communication means. The sensors provide an indication in load change to the monitoring portion 44 which may then go to an alarm status to indicate attendants of an issue.

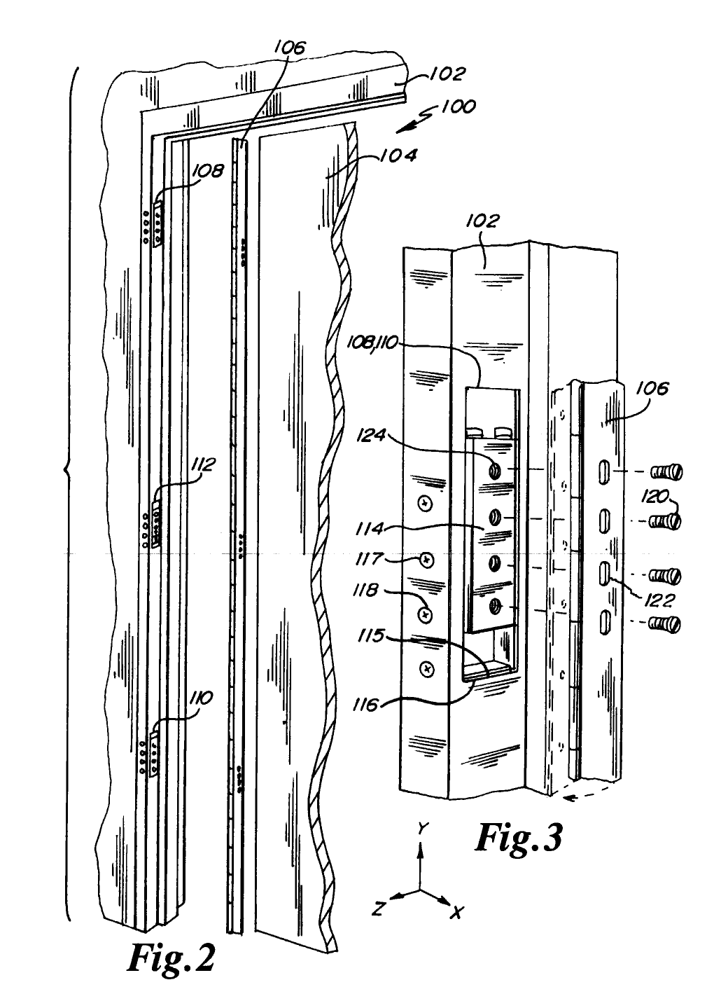

FIGS. 2-4 depict a load sensing door assembly 100 according to an embodiment of the present invention. Door assembly 100 generally includes a door frame 102 and a door 104 connected with a hinge 106. Door frame 102 can include a top opening 108, a bottom opening 110, and a middle opening 112 that can be used to contain supports for connecting hinge 106 to door frame 102. In one embodiment shown in FIG. 2, a continuous hinge 106 running substantially all of the height of the door 104 and door frame 102 can be used. Alternatively, a separate hinge half can be used at each opening 108, 110, 112.

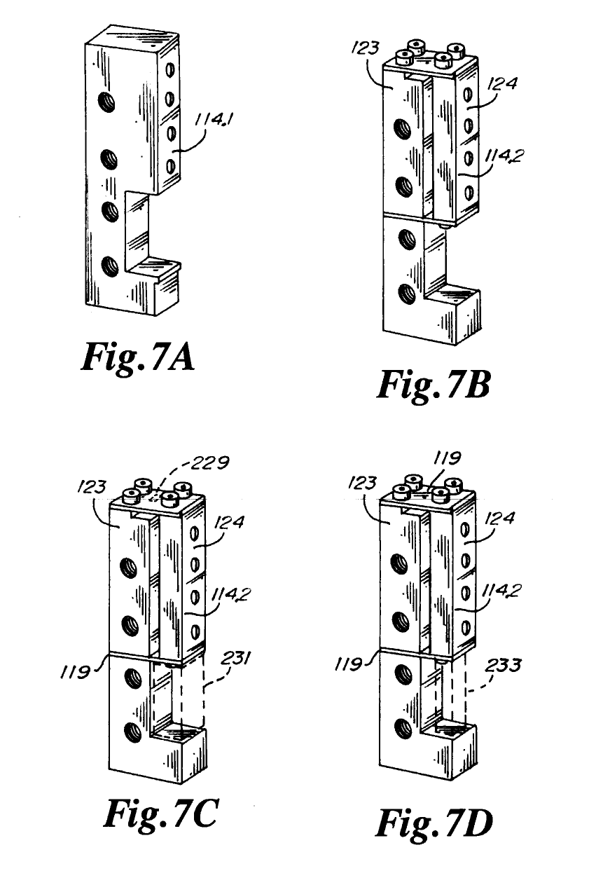

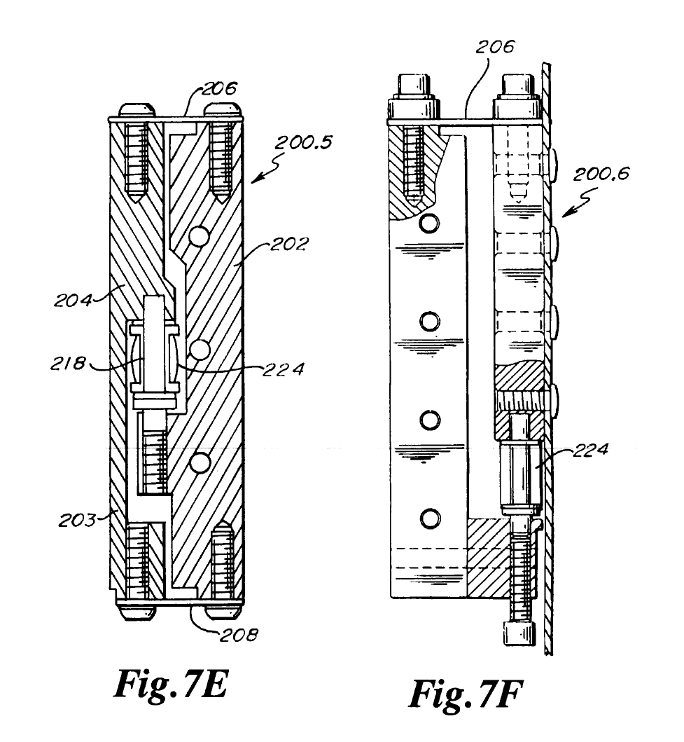

Referring to FIGS. 3, 7A and 7B, top opening 108 and bottom opening 110 in door frame 102 can each contain a support 114, 114.1, 114.2. The support can be a rigid support 114.1 or a resilient support 114.2. Supports 114, 114.1, 114.2 can have a shoulder 115 that can rest on a ledge 116 within opening 108, 110. Supports 114, 114.1, 114.2 can be affixed to door frame 102 with fasteners, such as screws 117, inserted through apertures 118 in door frame. Suitably, the supports 114, 114.1, 114.2 may be contained almost entirely or within the steel door frame 102. Support 114 can connect to hinge 106 with fasteners 120 inserted through apertures 122 in hinge 106 and into apertures 124 in support 114. In one embodiment, as shown in FIG. 3, hinge apertures 122 can be elongate in nature relative to fasteners 120 and support apertures 124. This allows the hinge 106 to move vertically, in the y direction with respect to fixed support 114.1 in response to loads applied by the door 104. This configuration minimizes the amount of the vertical load of the door 104 that is carried by the rigid supports 114.1. Thus, supports 114.1 can be configured such that they apply only a horizontal constraining forces retaining the hinge 106 against the door frame 102 without carrying any significant portion of the vertical load of the door 104 and hinge 106. In such an embodiment, the rigid supports 114.1 can be a simple one piece block as illustrated in FIG. 7A. Referring to FIGS. 2 and 7B, in another embodiment, a hinge 106 can include circular apertures and be fixedly attached to the resilient support 114.2. The resilience is provided by spring steel leaf springs 119 extending between a fixed bracket 123 and a floating bracket 124. Such supports can carry a portion of the load of the door 104 and still allow vertical, y direction, movement. The dual leaf spring arrangement effectively restricts any movement of the floating bracket 124, the attached hinge 106 securely affixed thereto, and the door 104 in the x-z plane, that is horizontally. The spring steel may be suitably selected and configured to provide desired load carrying capabilities and deflection.

Middle opening 112 in door frame 102 can include a load sensing support 200 that also connects hinge 106 to door frame 102. Load sensing support 200 can be fixed within opening 112 by fasteners 126 inserted through apertures in door frame 128 and into load sensing support 200. Hinge 106 can be connected to load sensing support 200 with fasteners 130 inserted through hinge apertures 132 and into load sensing support 200. Hinge apertures 132 can conform to fasteners 130 so that at least a portion of the load of the door 104 and hinge 106 is carried by the load sensing support 200. In embodiments where hinge 106 includes elongate apertures 122 for connecting to supports 114, essentially the entire load can be carried by the load sensing support 200. Load sensing support 200, as described in more detail herein, can sense the load of the door 104 and, accordingly, any changes in the load on the door 104. A communication cable 134 can transmit the load signal from the load sensing support 200.

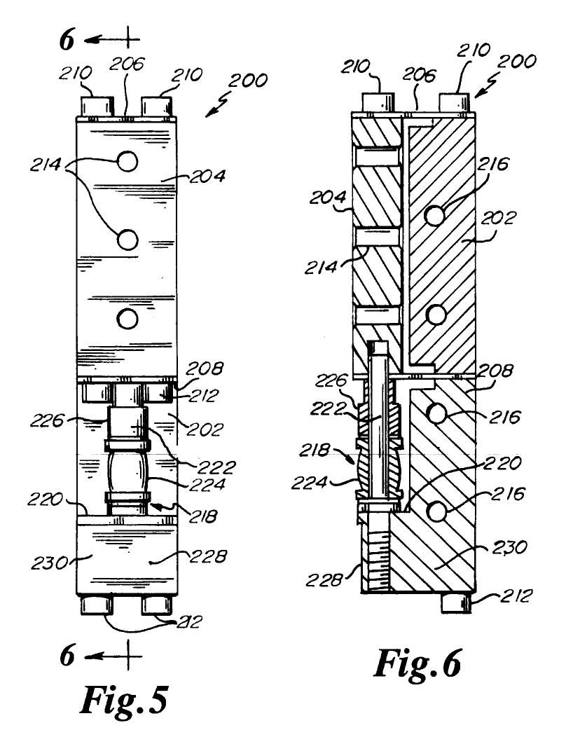

FIGS. 5 and 6 depict in more detail a load sensing support 200 according to an embodiment of the present invention. Load sensing support 200 comprises a fixed bracket 202 and a floating bracket 204. Floating bracket 204 is suspended from fixed bracket 202 by an upper leaf spring 206 and a lower leaf spring 208 connected to load sensing support 200 with upper fasteners 210 and lower fasteners 212, respectively. A plurality of hinge fixation apertures 214 extend into floating bracket 204 and can be used, with fasteners 130, to connect load sensing support 200 to hinge 106. Frame fixation apertures 216 extend into fixed bracket 202 and can be used to secure load sensing support 200 to the door frame 102 with fasteners 126. As depicted in FIGS. 5A and 5B, in one embodiment, leaf springs 206, 208 can be distinct parts. In another embodiment, leaf springs 206, 208 can be connected to one another such that they comprise opposing legs of one continuous generally U-shaped part.

A sensing assembly 218 extends vertically between floating bracket 204 and an upwardly facing ledge 220 of fixed bracket 202. Sensing assembly 218 can include a rod 222 for securing the sensor 224, configured as a spool shaped load cell, intermediate the floating bracket and the ledge 220 of the fixed bracket. The sleeve 226 extends between the floating bracket the top of the load cell. An adjusting screw 228 can extend into a lower portion 230 of the fixed bracket 202 and can be used to adjust the proportion of the load carried by the sensing assembly 218. The adjusting screw 228 can be adjusted to maintain the leaf springs 206, 208 in a horizontal position when the load sensing support 200 is supporting the door 104. This allows for most of or the entire weight of the door 104 to be supported by the sensing assembly 218.

In one embodiment, sensor 224 can be a Wheatstone bridge strain gauge and such a strain gauge on a support member. Strain gauge can be in the form a rod, as shown in FIG. 4, or in the form of a cylinder threaded onto a load rod, as shown in FIGS. 5 and 6. In other embodiments, sensor 224 can comprise other types of strain gauges, such as a helical strain gauge, or other types of sensors, such as a button-type pressure sensor. Alternatively, a strain gauge 229 may be disposed on the leaf springs as illustrated in FIG. 7c. In certain embodiments, resilient material 231, such as elastomeric material can be utilized as dampeners and/or to provide further support of the weight of the door. In certain embodiments, the resilient support may activate a switch 233, when the floating bracket travels a predetermined deflection due to loading that would correspond to a particular load on the door.

FIGS. 7E and 7F depict other embodiments of load sensing supports 200.5, 200.6 according to the present invention. The support 200.5 depicted in FIG. 7E includes a first leaf spring 206 at the top of the support 200, and a second leaf spring 208 at the bottom of the support 200. In this embodiment, the floating bracket 204 extends the same length as the fixed bracket 202 and has a portion 203 that extends below the sensing assembly 218. The support in FIG. 7F includes only an upper leaf spring 206.

When the load of the door 102 is increased, load sensor 224 detects the increase because it supports at least a portion of the weight of the door 102. In one embodiment, load sensor 224 can be configured to sense the load on the door 102 at all times. In another embodiment, load sensor 224 can be configured to sense the load only at certain times, such as only when the door 102 is closed, or when the load exceeds a certain amount causing a certain deflection of the leaf springs and floating bracket.

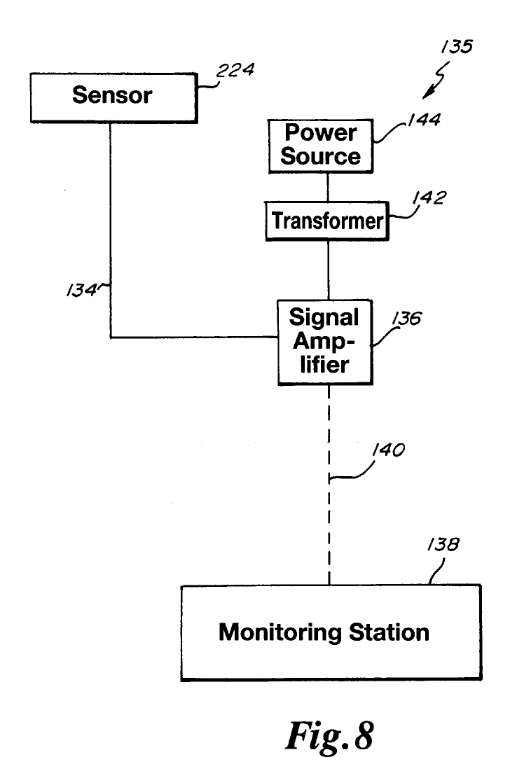

Door assembly 100 can be a part of a system for monitoring sensor 135, such as a system for monitoring patient isolation rooms or other secured rooms. Referring to FIG. 8, load sensor 224 can be connected to an in-line signal conditioning amplifier 136 via low voltage cabling 134. Signal conditioning amplifier 132 serves to condition the signal from the load sensor 224 into a suitable form to be read by a central monitoring station 138. Signals can be transmitted to central monitoring station 138 through a connection 140 that can be either wireless or a wired connection. A step-down voltage transformer 142 can be connected to a 120-volt power source 144 to power signal conditioning amplifier 136. In one embodiment, in-line signal conditioning amplifier 136 is an S7 In-line Signal Conditioning Amplifier produced by RDP Electronics Group. Central monitoring station 138 can include a computer (laptop or separate computer and monitor), keyboard, mouse, touchpad, or the like and a software program providing a user interface for monitoring the sensor measurements with the computer. System 135 can include numerous sensors relating to one or more patient rooms and one or more doors or other objections associated with each room. Various configurations of monitoring systems are known in the art, such as those in U.S. Pat. Nos. 7,042,349; 4,716,401; and 4,994,793. Said three patents are incorporated by reference as illustrating components and systems for providing monitoring functions.

As described above, middle opening 112 can contain a load sensing support 200 and top 108 and bottom 110 openings can contain non-load sensing supports 114. In another embodiment, top 108 and/or bottom 110 openings can also be configured to support a portion of the load of the door and to contain load sensing supports 200. The patient monitoring system 135 can add the load as read at each individual sensor 224 as a combined load caused by the door 104. Therefore, if, as the door 104 is opened and closed, the load of the door 104 shifts between the attachment points, there will not be a false reading of a load increase on the door because the overall load will remain the same due to an increase in the load at any one sensor causing a decrease at one or more of the other sensors.

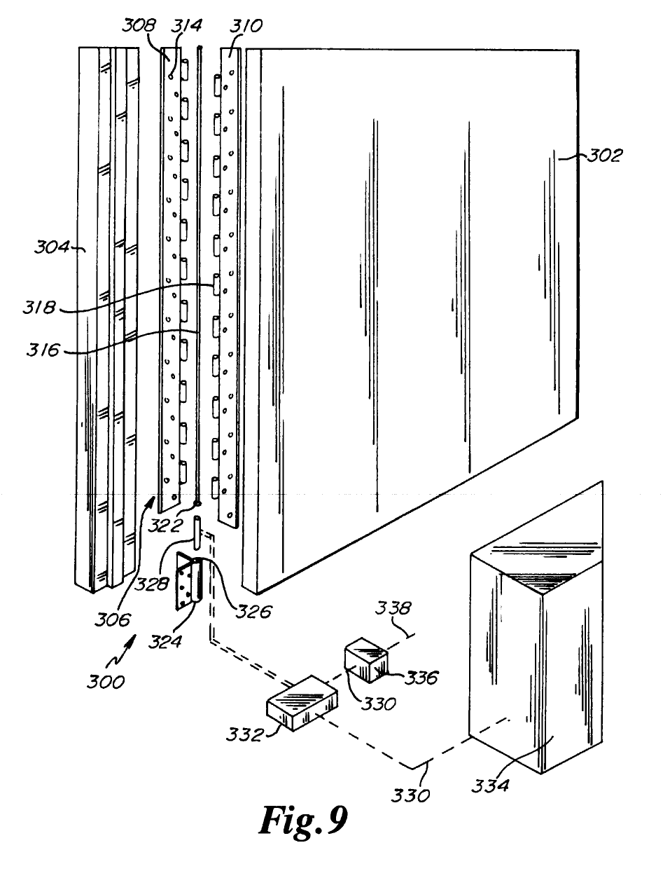

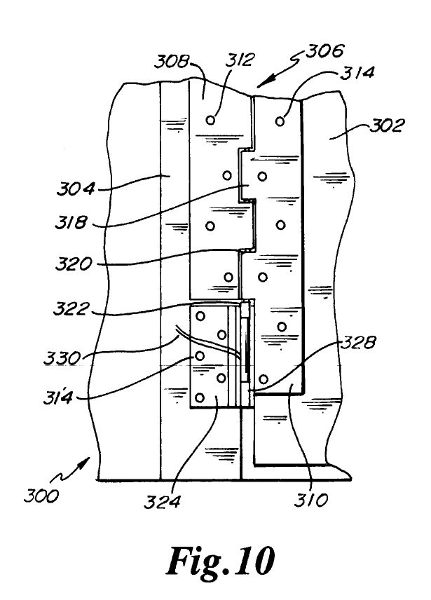

Referring to FIGS. 9 and 10, there can be seen an alternate embodiment of a load-sensing door assembly 300 according to an embodiment of the present invention. Door assembly 300 generally includes a door 302 connected to a door jamb 304 with a hinge assembly 306. Hinge assembly 306 can include a first hinge half 308 connected to door jamb 304 and a second hinge half 310 connected to door 302. First hinge half 308 and second hinge half 310 can connect to door jamb 304 and door 302, respectively, by inserting fasteners 312 through apertures 314 and into door jamb 304 or door 302. Hinge halves 308, 310 can be rotatively connected to one another by a pin 316 inserted through alternating knuckles 318 in hinge halves 308, 310. A plurality of washers 320 can be threaded onto pin 316 and positioned between adjacent knuckles 318 in first 308 and second 310 hinge halves to distribute the load of the door 302. A bearing 322 can be disposed at the bottom of pin 316. In one embodiment, hinge assembly is an FM-300 edge mount hinge manufactured by Markar Architectural Products, Inc. of Pomona, Calif.

A bearing bracket 324 can also be attached to door jamb 304 with fasteners 314. Bearing bracket 324 can be positioned below first hinge half 308 and across from a bottom portion of second hinge half 310. Bearing bracket 324 can include an axial slot 326 extending through bearing bracket 324 and configured to contain a load sensor rod 328. Bearing bracket 324 can be positioned such that door bearing 322 of pin 316 bears against load sensor 328.

Load sensor 328 is capable of detecting and transmitting the amount of weight supported by rod 328. In one embodiment, load sensor rod 328 can be a strain gage of the type manufactured by Hitec Products, Inc. of Ayer, Mass. As depicted in the embodiment of FIG. 9, a portion of the weight of the door 302 is supported by load sensor rod 328 as transmitted through door bearing 322. The remainder of the weight of the door 302 is supported by washers 320 between knuckles 318 of hinge halves 308, 310. Washers 320 can be positioned between all adjacent knuckles 318, or between a select number of knuckles 318. If there are too few washers, there may be excessive wear on the washers, causing them to fail prematurely. However, if there are too many washers (greater than 20) the load is distributed to an extent that accuracy of the load reading can be diminished. In one embodiment, the optimal number of washers is between six and eight washers. Washers 320 can be comprised of various materials, including, for example, steel, plastic, or elastomeric materials. In one embodiment, washers 320 are partially comprised of steel and partially comprised of an elastomeric material. This provides for durable support while allowing smooth operation of the hinge assembly 306 when the door 302 is opened and closed. In another embodiment, washers 320 comprised of different materials can be used at different points along the hinge assembly 306. For example, steel washers can be used near the top and the bottom of the hinge assembly 306 while plastic washers can be used in between. When the load of the door 302 is increased, load sensor rod 328 detects the increase because it supports at least a portion of the weight of the door 302.

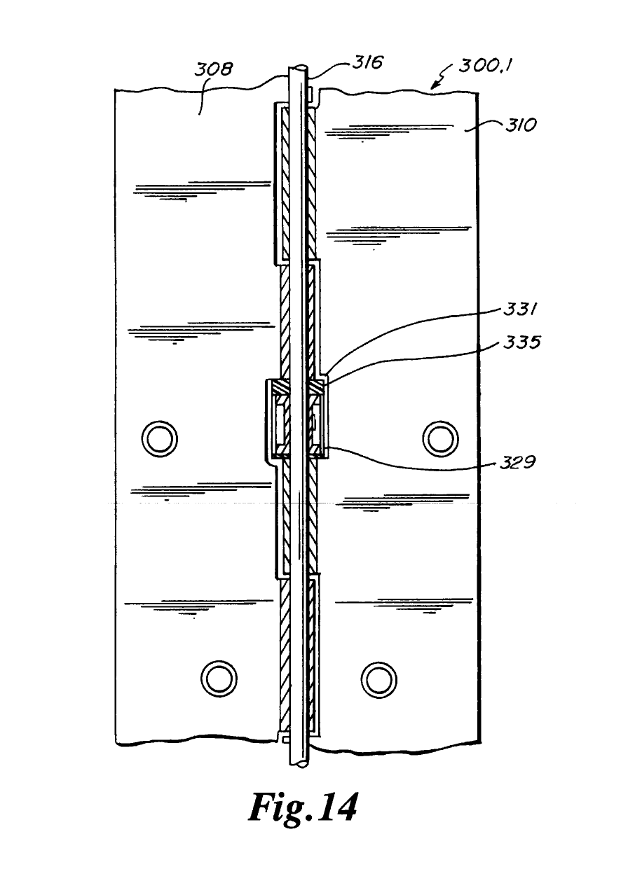

In another embodiment, a door assembly 300.1 can employ a generally spool-shaped sensor assembly 329 as shown in FIG. 14. A strain gauge, such as a Wheatstone bridge, can be wrapped around the outside of a spool-shaped structure to form the sensor assembly. Referring to door assembly 300, this sensor assembly can be utilized by inserting pin 316 through the opening in the spool and situating the assembly between the hinge halves 308, 310. This allows for elimination of the bearing bracket 324 of FIG. 9, which can save on manufacturing costs. In one embodiment, the sensor assembly can be situated between the hinge halves 308, 310 by removing a portion of the material of the hinge halves 308, 310 to create an opening 331 for containing the sensor. In one embodiment, a lubricant can be applied to the hinge and pin to reduce friction between the hinge halves and between the hinge halves and the pin. Such friction can cause the load detected by the sensor to vary unreliably, and therefore use of such a lubricant can increase the reliability of the measurements made by the system. Low friction polymer washers 335 may also be used.

Spool type sensors as illustrated herein are available from HITEC Corporation, Littleton, Mass. 01460.

Load sensor rod 328 can also be connected to an in-line signal conditioning amplifier 332 via low voltage cabling 330. Signal conditioning amplifier 332 can condition the signal from the load sensor rod 328 into a suitable form to be read by a central monitoring station 334. Signals can be transmitted to central monitoring station 334 either wirelessly or through a wired connection. A step-down voltage transformer 336 can be connected to a 120-volt power source 338 to power signal conditioning amplifier 332. Central monitoring station 334 can include a computer (laptop or separate computer and monitor), keyboard, mouse, touchpad, or the like and a software program providing a user interface for monitoring the sensor measurements with the computer.

In one embodiment, door assemblies as described herein can be utilized in a hospital as a suicide-prevention aid to monitor attempts by a patient to use a door or door hardware to commit suicide. Door assembly can be installed in a patient's room and constructed substantially as described above, for example. Load sensor provides a signal indicative of the load caused by the door to a central monitoring station. In one embodiment, central monitoring station is located at a nurse's station located near to the patient's room. If the patient attempts to hang from the door or door hardware, the load sensor will instantaneously sense the increased load on the door and transmit the information to the central monitoring station. An alarm or other signal at the central monitoring station can alert appropriate personnel that an unexpected load is on the door. Personnel can then go to the patient's room to investigate the cause of the increased load on the door and put a stop to any improper activity in a timely fashion. Central monitoring station can be configured to monitor door assemblies for numerous rooms at the same time. Sensing assemblies can also be configured to be used with other room fixtures that could present a danger of hanging in addition to doors.

In other embodiments, door assemblies as described herein can be used in other applications. Door assembly can be employed in any situation where it may be desirable to monitor the load carried by a door. Proximity sensors, such as hall effect, or inductive sensors, or capacitive sensors can be configured to identify when the door is open or closed and, in some embodiments, the monitoring can occur only when the door is closed. Such sensors can further provide an alarm that the door has been opened by the patient.

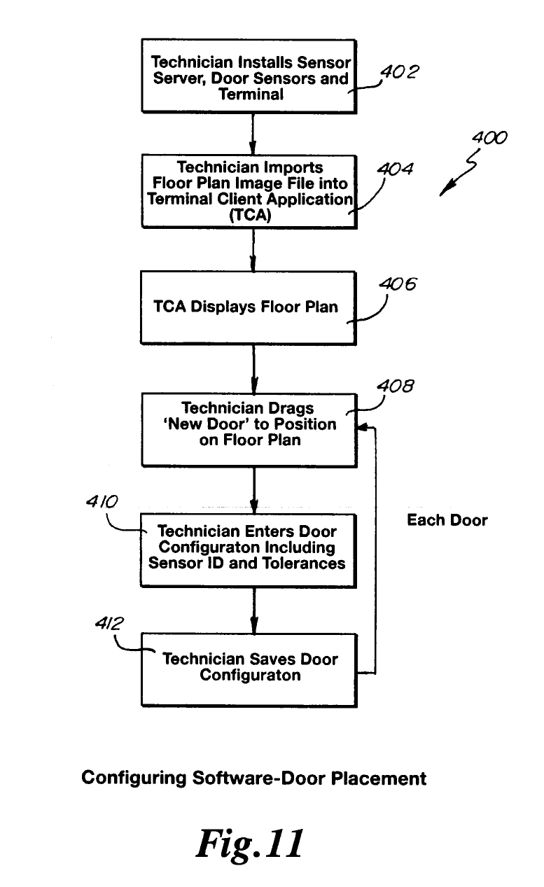

FIG. 11 is a flowchart depicting a process for configuring a software application 400 that can be used with a monitoring system according to an embodiment of the present invention. Initially, at step 402 sensors are installed on the desired objects as described herein. A remote monitoring server and monitoring terminal with an associated terminal client application can also be installed, or software for interfacing with the sensors can be installed on existing servers and terminals. A floor plan of the area to be monitored can then be imported into the terminal at step 404 and an operator can display the floor plan at step 406. The operator can then activate a new object such as a door or other hardware on the floor plan at the location of the particular object at step 408. At step 410, the operator can then configure the new object by entering identification for the sensor associated with the object and other relevant information, such as the known weight of the object and the tolerance for sounding an alarm based on a weight increase. The configuration for the new object can then be saved into the terminal at step 412. Steps 408, 410 and 412 can then be repeated for each object that is to be monitored by the system.

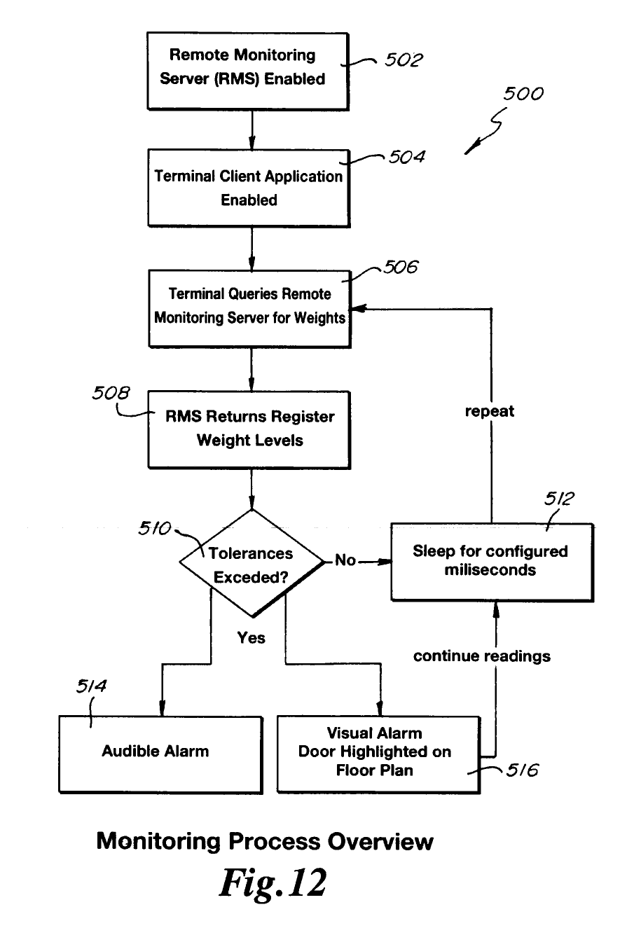

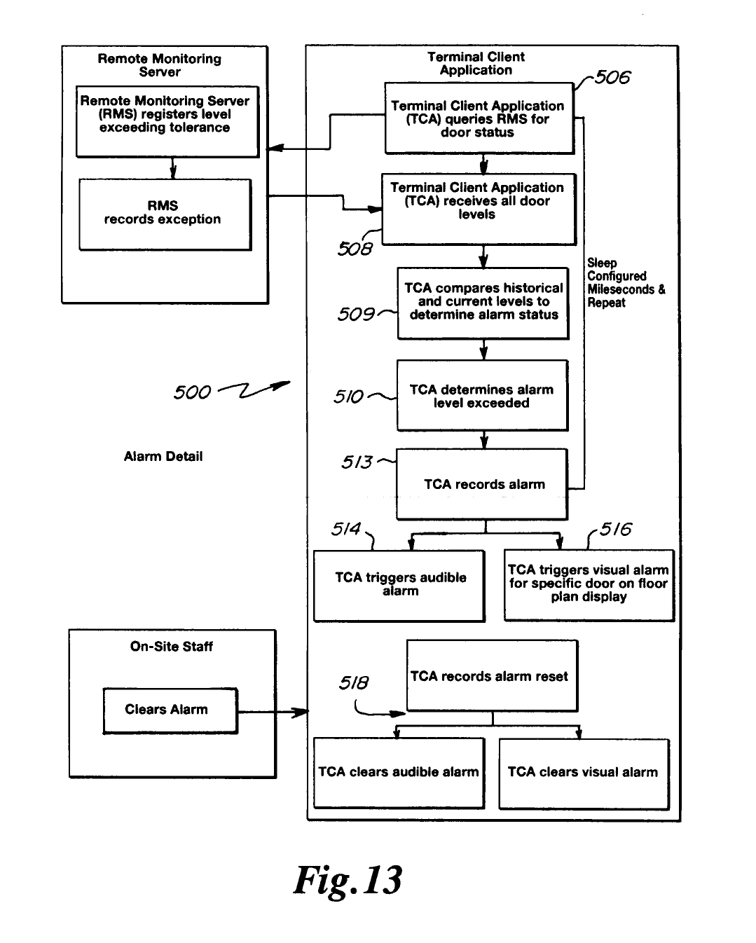

Flowcharts depicting a monitoring process 500 according to an embodiment of the present invention are depicted in FIGS. 12 and 13. First, the remote monitoring server and terminal client application are enabled at steps 502 and 504, respectively. The terminal queries the server for the weights sensed by the various sensors in the system at step 506 and receives the weights from the server at step 508. The terminal then determines whether any of the weights exceed the programmed tolerances for the related object at step 510. As shown in FIG. 13, this can include comparing historical readings for an object to the current reading at step 509. If no tolerances are exceeded, the terminal waits for a preconfigured period of time at step 512, and then queries the server for the weights again. In one embodiment, the time that the terminal waits is determined in a predetermined number of milliseconds so that any change in weight can be quickly discovered. If a weight tolerance is exceeded, the system then sounds an audible alarm at step 514 and/or a visual alarm on the terminal at step 516 indicating the location of the exceeded tolerance. When the terminal determines that an alarm is shown, it can also record the occurrence as shown at step 513 in FIG. 13. The terminal can continue to request weight readings from the server as the alarms sound, so that any further weight increase or decrease can be detected. Once on-site staff has determined the cause for the alarm and cleared the alarm, the terminal can record an alarm reset and clear the alarms at step 518.

Although rooms can be initially constructed to utilize door assemblies and sensing systems as described herein, existing hospitals and other buildings can be retrofit with such assemblies. Existing doors and hinges can be removed from door frames and a load sensing support and, optionally, other supports as described herein can be installed. If the door frame into which the supports are being installed does not include the required openings, such openings can be made in the door frame. The same hinge and door or a new hinge and/or door can then be attached to the new supports. Load sensing support can be configured to transmit readings to a computer monitoring station as described herein.

The foregoing is considered as illustrative only of the principles of the disclosure. Further, since numerous changes and modifications will readily occur to those skilled in the art, it is not desired to limit the disclosure to the exact construction and operation shown and described, and accordingly, all such suitable changes or modifications in structure or operation which may be resorted to are intended to fall within the scope of the claimed disclosure. For example, alternative sensors, such as strain gauges, could be applied directly to hinge plate portions that are stressed by the load of the door. The invention includes adapting existing installations to include load monitoring on the doors as described above. Similarly, load monitoring by use of load cells, strain gauges, and other sensors may be associated with other fixtures or hardware in isolation rooms where there is a risk of a suicide attempt by hanging. Such monitoring can often be effectively concealed from the patient by discrete positioning of sensors.

While the description of the disclosure is amenable to various modifications and alternative forms, specifics thereof have been shown by way of example in the drawings and have been described in detail. It should be understood, however, that the description of the disclosure is not to limit the disclosure to the particular embodiments described. On the contrary, the intention is to cover all modifications, equivalents, and alternatives.

1. A system for monitoring a load on at least one door assembly in a secured patient facility, comprising:
a secured room for containing a patient;
a door frame provided in an opening to the room;
a door situated in the door frame and selectively movable to secure the opening;
a hinge connecting the door to the door frame;
a sensor configured to take measurements of a load caused by the door and transmit a signal indicative of the measurements; and
a remote monitoring station for receiving the signal indicative of the measurements that allows remote monitoring of the load.

2. The system of claim 1, wherein the sensor is a strain gauge.

3. The system of claim 1, wherein the sensor is positioned proximate an attachment point between the door frame and the hinge.

4. The system of claim 1, further comprising a load sensing support positioned in an opening in the interior of the door frame that connects the hinge to the door frame and carries the load caused by the door, and wherein the sensor is integrated with the load sensing support.

5. The system of claim 4, further comprising a plurality of movable supports positioned in an interior of the door frame for connecting the hinge to the door frame.

6. The system of claim 4, wherein the load sensing support includes a fixed bracket and a floating bracket connected to each other by at least one leaf spring.

7. The system of claim 6, wherein the sensor is positioned generally vertically between the fixed bracket and the floating bracket.

8. The system of claims 7, wherein the at least one leaf spring is positioned generally horizontally between the fixed bracket and the floating bracket.

9. The system of claim 3, wherein there are a plurality of attachments points between the door frame and the hinge, and wherein a second sensor is disposed proximate a second attachment point.

10. The system of claim 1, wherein the remote monitoring station is configured to provide an alarm in response to an increase in one of the measurements as indicated by the signal.

11. The system of claim 10, wherein the alarm is provided only if the increase exceeds a predetermined threshold.

12. A system for monitoring a secured patient facility, comprising:
a plurality of secured rooms for containing patients;
a door frame provided in an opening to each room;
a door situated in each door frame and selectively movable to secure the opening;
a hinge connecting each door to the associated door frame;
a sensor configured to take measurements of a load caused by each door and transmit a signal indicative of the measurements; and
at least one remote monitoring station for receiving the signals indicative of the measurements that allows remote monitoring of the load caused by each door.

13. The system of claim 12, further comprising one or more objects other than the door positioned in one or more of the rooms and a sensor configured to take measurements of the load caused by each of the objects.

14. The system of claim 12, wherein the remote monitoring station is configured to provide an alarm in response to an increase in one of the measurements as indicated by the signal.

15. The system of claim 14, wherein the alarm is provided only if the increase exceeds a predetermined threshold.

16. The system of claim 12, wherein there are at least two remote monitoring stations.

17. The system of claim 16, wherein the at least two remote monitoring stations receive the signals from different sensors.

18. The system of claim 17, wherein each remote monitoring station receives the signal from each sensor that is located closest to that remote monitoring station.

19. A system for monitoring a load on at least one object in a secured patient facility, comprising:
a secured room for containing a patient;
an object provided in the room;
a sensor configured to take measurements of a load caused by the object and transmit a signal indicative of the measurements; and
a remote monitoring station for receiving the signal indicative of the measurements that allows remote monitoring of the load.

20. The system of claim 19, wherein the secured room includes a plurality of walls and a ceiling, and wherein the object is secured to one or more of one of the walls or the ceiling.

21. The system of claim 19, wherein the object is selected from the group consisting of: a door, door hardware, a cabinet, a shelf, a light fixture, fire control equipment, signage, a window, and window hardware.

22. The system of claim 19, wherein the remote monitoring station is configured to provide an alarm in response to an increase in one of the measurements as indicated by the signal.

23. The system of claim 22, wherein the alarm is provided only if the increase exceeds a predetermined threshold.

24. An apparatus for measuring a load imparted by an object, comprising:
a fixed bracket;
a floating bracket movable relative to the fixed bracket;
at least one leaf spring connecting the fixed bracket and the floating bracket; and
a sensor for measuring a load imparted by an object.

25. The apparatus of claim 24, wherein the sensor is a strain gauge.

26. The apparatus of claim 25, wherein the sensor is disposed generally vertically between a downwardly facing portion of the floating bracket and an upwardly facing portion of the fixed bracket.

27. The apparatus of claim 26, wherein the leaf spring extends generally horizontally from the fixed bracket to the floating bracket.

28. The apparatus of claim 24, further comprising an adjustment screw for adjusting the proportion of the load of the object on the sensor.

29. An isolation room for containing a patient in a secured facility, comprising:
a plurality of walls, a ceiling and a floor defining an enclosed space;
an opening in one of the walls defining a door frame;
a door situated in the door frame and selectively movable to secure the opening; and
a sensor configured to take measurements of a load caused by the door and transmit a signal indicative of the measurements to a remote monitoring station.

30. The isolation room of claim 29, further comprising one or more objects other than the door positioned in the isolation room and a sensor configured to take measurements of the load caused by each of the objects and transmit a signal indicative of the measurements to a remote monitoring station.

31. A secured patient facility, comprising:
a plurality of isolation rooms for containing patients;
a door frame provided in an opening to each isolation room;
a door situated in each door frame and selectively movable to secure the opening;
a hinge connecting each door to the associated door frame;
a sensor configured to take measurements of a load caused by each door and transmit a signal indicative of the measurements; and
at least one remote monitoring station for receiving the signals indicative of the measurements that allows remote monitoring of the load caused by each door.

32. The facility of claim 31, further comprising one or more objects other than the door positioned in one or more of the rooms and a sensor configured to take measurements of the load caused by each of the objects.

33. The system of claim 31, wherein the remote monitoring station is configured to provide an alarm in response to an increase in one of the measurements as indicated by the signal.

34. The system of claim 33, wherein the alarm is provided only if the increase exceeds a predetermined threshold.

35. The system of claim 31, wherein there are at least two remote monitoring stations.

36. The system of claim 35, wherein the at least two remote monitoring stations receive the signals from different sensors.

37. The system of claim 36, wherein each remote monitoring station receives the signal from each sensor that is located closest to that remote monitoring station.

38. A method of constructing a secured patient facility, comprising:
identifying an object to be installed in a room for housing a patient as an object that a patient could use to hang from in committing suicide by hanging;
installing a sensor configured to take measurements of a load caused by the object and transmit a signal indicative of the measurements; and
configuring a remote monitoring station to receive the signal indicative of the measurements that allows remote monitoring of the load.

39. The method of claim 1, wherein the step of configuring the remote monitoring station includes configuring the remote monitoring station to receive signals from a plurality of sensors related to a plurality of different objects.

40. The method of claim 1, wherein the step of configuring the remote monitoring station includes configuring the remote monitoring station to provide an alarm signal if the signal indicates that the measurements have increased above a predetermined threshold.

41. A method of retrofitting a secured patient facility with a patient monitoring system, comprising:
identifying an existing object within a room for housing a patient as an object a patient could use to hang from in committing suicide by hanging;
installing a sensor configured to take measurements of a load caused by the object and transmit a signal indicative of the measurements; and
configuring a remote monitoring station to receive the signal indicative of the measurements that allows remote monitoring of the load.

42. The method of claim 4, wherein the step of configuring the remote monitoring station includes configuring the remote monitoring station to receive signals from a plurality of sensors related to a plurality of different objects.

43. The method of claim 4, wherein the step of configuring the remote monitoring station includes configuring the remote monitoring station to provide an alarm signal if the signal indicates that the measurements have increased above a predetermined threshold.

44. A method of monitoring one or more patients in a secured facility, comprising:
housing a patient with in an isolation room including at least one sensor identified with an object that is configured to take measurements of a load caused by the object and transmit a signal indicative of the measurements; and
monitoring the measurements as indicated by the signal at a remote monitoring station.

45. The method of claim 7, wherein the step of monitoring the measurements includes monitoring the signal from a plurality of sensors.

46. The method of claim 7, further comprising receiving an indication of an alarm condition when the signal indicates that the measurements have increased above a predetermined threshold.

47. The method of claim 9, further comprising visually inspecting the isolation room in response to the indication of the alarm condition.
